(19) United States
(12) Patent Application Publication
(10) Pub. No.: US 2014/0244724 A1
(43) Pub. Date: Aug. 28, 2014

(54) SYSTEM FOR REGISTERING AND MANAGING A DISTRIBUTED NETWORK OF STORAGE DEVICES AND METHOD OF USE THEREOF

(71) Applicant: MXN Corporation, Woodstock, GA (US)

(72) Inventors: George R. Patrick, Marietta, GA (US); Michael Lippman, Cartersville, GA (US); Bryan Moore, Flowery Branch, GA (US)

(73) Assignee: MXN Corporation, Woodstock, GA (US)

(21) Appl. No.: 14/011,825

(22) Filed: Aug. 28, 2013

Related U.S. Application Data
(63) Continuation-in-part of application No. 13/779,228, filed on Feb. 27, 2013.

(51) Int. Cl. H04L 29/08

(52) U.S. Cl. CPC H04L 67/1097
USPC 709/203

(57) ABSTRACT

A system for registering and managing a distributed network of storage devices and method of use thereof including, in general, providing a storage device with built-in proprietary operating system installed on a CPU and computer memory, plugging the storage device into a network of computers devices and other storage devices, powering the storage device via power over the network cable, communicating with a storage manager and to register with the storage manager, executing a storage device deployment plan based on existing storage devices and predefined distributed storage rules, providing a storage task of a set of storage services for a networked computer device, providing backup storage services for another storage device, communicating the storage status directly to a networked computer device, and, thus, functions as a storage system made up of many individual, identical or very similar storage devices that collectively provide storage services to multiple computing devices.

### CROSS-REFERENCE TO RELATED APPLICATIONS

To the full extent permitted by law, the present United States Non-provisional patent application, is a Continuation-in-Part of, and hereby claims priority to and the full benefit of United States Non-provisional application entitled “Eportal System and Method of use thereof,” having assigned Ser. No. 13/779,228, filed on Feb. 27, 2013, incorporated herein by reference in its entirety.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The disclosure generally relates to computer networking, and more specifically to a system of networking and managing computer devices.

2. Description of Related Art

The disclosure relates generally to a system of networked computer devices, networked storage devices, and a method of using the same.

One previous approach was to use a direct-attached storage (DAS) or data center. DAS refers to a data storage system that is directly attached to a server or workstation. One disadvantage of this approach is that DAS is unable to share data or unused resources with other servers. Another problem is that all the data storage was gathered in one place called a data center.

Another approach is to use storage area network (SAN). SAN refers to a high-speed special purpose network that interconnects and provides access to consolidated block storage devices, such as disc arrays. One disadvantage of this approach is that block storage devices are bunched closely together in a single storage area, room or device rack.

Another approach is to use network-attached storage (NAS). NAS refers to a dedicated storage device that is set up with its own network address and provides file-based storage services to other devices on the network. One disadvantage of this approach is that these prior storage devices are not inherently manageable as a whole system as well as not inherently networkable.

Moreover, DAS, SAN, and NAS storage device utilize Microsoft, Linux-based, or proprietary operating systems, which require specialized IT personnel to configure, program, setup, establish rules for installation, maintenance, assignment, and operation of such storage devices, individually, one device at a time to fulfill some previously identified and discrete purpose. Further, DAS, SAN, and NAS storage device have large power requirements, including 3 phase 30 amp/60 hertz power supply requirements for direct storage device power and air conditioning cooling requirements for storage device heat dissipation requirements. Furthermore, storage systems, based on the above storage devices, are not aware of the other storage systems and operate independently, or have other than a direct relationship with the computers that they are assigned to. This results in storage systems that are harder to deploy and network than they ought to be.

Therefore, it is readily apparent that there is a recognized unmet need for a system for registering and managing a distributed network of storage devices and method of use thereof, wherein such storage device is small in size, solid state, powered via a network cable, is installed by simply plugging the storage device into a network cable, and is automatically configured, networked, and placed in service as a part of a whole storage system that functions as a networked web of storage devices.

### SUMMARY

Briefly described, in an example embodiment, the present apparatus and method overcomes the above-mentioned disadvantage, and meets the recognized need for a system for registering and managing a distributed network of storage devices and method of use thereof including, in general, providing a storage device with built-in proprietary operating system installed on a CPU and computer memory, plugging the storage device into a network of computers devices and other storage devices, powering the storage device via power over the network cable, communicating with a storage manager and registering with the storage manager, executing a storage device deployment plan based on existing storage devices and predefined distributed storage rules, providing a storage task of a set of storage services for a networked computer device, providing backup storage services for another storage device, communicating the storage status directly to a networked computer device, and, thus, functions as a storage system made up of many individual, identical or very similar storage devices that collectively provide storage services to multiple computing devices.

In a preferred embodiment, a distributed network storage system, the storage system including a server, network communications, and a storage device, wherein the storage device and the server communicate via network communications, and wherein the storage device comprises a custom operating system, and wherein the storage device comprises a custom storage policy provided by a storage engine on the server, and wherein the storage device provides plug.

In still a further exemplary embodiment of the method for adding storage to a network storage system, wherein the method comprises the steps of plugging a storage device into a communication cable in communication with a networking switch in network communication with a server, wherein the storage device is configured with a proprietary operating system, wherein the storage device is powered via a power over Ethernet via the networking switch, registering the storage device with the server via a storage engine; wherein the storage engine utilizes link layer datagram protocol (LLDP) communication between the storage device and the networking switch, and wherein the storage engine communicates a storage policy to the storage device, and wherein the storage policy governs an operation of the storage device.

In still a further exemplary embodiment of the method for managing a network storage system, wherein the method comprises the steps of providing a storage device in communication with a networking switch in network communication with a server and a computing device in network communication with the server, querying the computing device to determine a system storage requirement, querying the storage device to determine a system storage requirement, generating a general rule of operation via a management engine on the server, wherein the management engine establishes a storage policy to govern an operation of the storage device.

Accordingly, a feature of the system for registering and managing a distributed network of storage devices and method of use is its ability to provide a new distributed storage system, which is more reliable and survivable than existing storage systems, because instead of a centralized, monolithic set of storage devices, this system will have components spread across the entire network based on a highly networked web of storage devices working to some common purpose, as opposed to a more monolithic system of different storage devices, all with their own individual rules.

Another feature of the system for registering and managing a distributed network of storage devices and method of use is its ability to automatically register a storage device with a central manager, which then controls, assigns roles, updates, and maintains functional operation toward a common storage system purpose.

Still another feature of the system for registering and managing a distributed network of storage devices and method of use is its ability to enable management as a whole storage system where the system is aware of the status and tasks of the storage devices that provide storage services to computing devices on the system.

Yet another feature of the system for registering and managing a distributed network of storage devices and method of use is its ability to be plug and play wherein storage devices may be added without the assistance of qualified IT personnel. An installer merely has to unbox the storage device and connect it to a network connection and the storage manager (Storage Engine) application automatically includes the storage device in the storage system and assigns it a new role and tasks.

Yet another feature of the system for registering and managing a distributed network of storage devices and method of use is its ability to network a variety of storage devices and storage purpose since each storage device is given its operating guidance from storage manager (Storage Engine) application. For example, storage manager (Storage Engine) application rules may assign storage devices the task of providing primary or back-up storage, or some other storage task, which provide many different storage functions and capabilities from the same storage devices.

Yet another feature of the system for registering and managing a distributed network of storage devices and method of use is its ability to utilize Link Layer Datagram Protocol (LLDP). LLDP is an application that registers the storage devices and ePortal computing devices with the connected network as access points in a network to advertise information about such devices to other nodes on the network and to enable storage manager (the Storage Engine) to gather and store information, such as status and storage needs of the ePortal networked computer devices and the status of the networked storage devices and specify operation tasks for the storage device. Moreover, the LLDP application allows the switch to automatically provide power to the storage device, and to automatically move that storage device to the correct virtual network segment.

Yet another feature of the system for registering and managing a distributed network of storage devices and method of use is its ability to utilize power over ethernet (POE) to power storage devices making them pluggable into the network anywhere there is an Ethernet cable connected to a network switch.

Yet another feature of the system for registering and managing a distributed network of storage devices and method of use is its ability to utilize the proprietary operating system of the ePortal networked computer devices—a built-in proprietary operating system installed on a CPU and computer memory of the storage device that will automatically discover the storage manager (the Storage Engine) and register storage device with the storage manager (the Storage Engine).

Yet another feature of the system for registering and managing a distributed network of storage devices and method of use is that such storage system is much easier to install, modify, increase, or decrease than conventional storage systems, because the storage devices automatically register themselves with the storage manager (Storage Engine)—automatic installation of storage device(s)—storage devices are unboxed, plugged in to any suitable network connection, and then the storage manager (the Storage Engine) registers and deploys the new storage device based on the status and tasks of the existing networked storage devices without the need for individual configuration of the storage device.

Yet another feature of the system for registering and managing a distributed network of storage devices and method of use is its ability of the storage manager (the Storage Engine) to have predetermined rules for the deployment and use of storage devices based on the types and speeds of the network connections that bind this new storage device to the local network, the type and size of storage needed, and the type and size of storage capabilities of the new storage device.

Yet another feature of the system for registering and managing a distributed network of storage devices and method of use is its ability of the storage manager (the Storage Engine) to communicates with the server-based manager of the ePortal networked computer devices and to know the status and storage needs of the ePortal networked computer devices, and thus, enable the distributed storage system to adapt to the storage requirements of the ePortal networked computing devices.

Yet another feature of the system for registering and managing a distributed network of storage devices and method of use is its ability to provide expanded storage device functionality for users, such as, for exemplary purposes only, students, teachers and student administrators.

Yet another feature of the system for registering and managing a distributed network of storage devices and method of use is its ability to utilize android based storage operating system.

The apparatus and method includes an eportal system with a server and a client device. In one embodiment, the client device is not configurable by common users of the client device, and the server includes an admin system that manages and logs all content.

According to its major aspects and broadly stated, the present disclosure describes an eportal system having a server, network communications, and a client device, with the client device and the server communicating via the network communications. The client device has a custom ROM and a custom browser. A user utilizing the client device is prevented from configuring or modifying the client device. The server has an Admin System and a datastore, the datastore having registration information, and the registration information relates to students' names, grade levels, and classes. The eportal system also has notifications, the notifications being sent from the server to the client device(s), and the notifications being messages, exams, content, and the like. The client device sends acknowledgement to the server in response to notifications, and the acknowledgement has response data that is stored in the datastore. Administrators, such as teachers, can access the response data, and this access includes reading and editing the response data.

The network communications coming from the client device(s) are forwarded to the server and filtered before, and if, they are permitted to enter the World Wide Web and/or other servers.

Utilizing the eportal system includes registering a client device, wherein the client device has a custom ROM, and users of the client device are prevented from modifying the client device. Another step is receiving network communications from the client device to a server, wherein the server has an Admin System and datastore. More steps include sending a notification with content from the server to the client device, sending acknowledgement from the client device to the server, the acknowledgment having response data, and storing the response data in the datastore. The client device has a browser and applications, and utilization also includes the step of filtering the network communications that are received by the server from the client device.

More specifically, the present disclosure of an embodiment is an eportal system, the eportal system having a client device, a server, at least one network, and notifications. The network includes known wireless networks and new wireless networks.

The client device includes a custom ROM, a browser, applications, and a unique portal number. The server includes an admin system, a datastore, registration information, individual login(s), response data, notification content, and acknowledgement(s).

In an exemplary embodiment, when a client device is turned on for the first time, the client device will receive information relating to possible schools and school districts that the client device will be used in. The user will then enter their name, student ID number, and school name. The server will then associate this information with the client device's unique portal number, which is within the custom ROM, and the client's devices MAC address. Thus, the server will be storing how to address this user individually, or as part of a group of people that includes this user.

In another embodiment, a school system sends a data file of students, student ID numbers, school attended, grade level, and any other relevant information, to the distributor of the client devices. This information is loaded into the server's datastore, and when the client device is turned on for the first time only the student's ID number need be entered, and from this piece of information the server can associate the client device with the correct student, school, grade, classes, or any other information that has been entered.

In one embodiment, the client devices are given a list of wireless networks that they are permitted to connect to, as well as the associated passwords, security, and any other information needed. In this embodiment, only administrators can enable client devices to connect to “new” wireless networks.

In another embodiment, common users of client devices are permitted to connect the client devices to any wireless network for which they have the appropriate information. In yet another embodiment, the ports or plugs that the client devices have preferably, although not necessarily, only allow charging of the client devices' battery, and not to add hard-drive space, share data, or install additional software.

In another embodiment, when the client device is registering, the client device queries the Admin System to see if registration information exists for the supplied student ID. If not, registration information is requested of the client device's user, and subsequently, assuming the entered information is correct and/or acceptable, the client device is registered with the registration information.

In one embodiment, notifications are generated by an administrator. The administrator decides on the recipients of the notification, and also decides what content the notification will include. The notification can include any type communication from the server to client devices, or vice versa, and can include, for exemplary purposes only and without limitation, messages, questions for a quiz or test, and content, including multimedia content or links to any of above, or the content may include such things as emergency and/or administrative type communications to teachers.

The administrator wishing to send a notification logs into the Admin System using their individual login. The administrator then creates a notification and chooses recipients of the notification. The notification is stored by the Admin System for retrieval by client devices by being stored in the datastore. Administrators may view notifications, acknowledgement of notifications, manage/delete notifications or acknowledgments. More specifically, administrators may view notifications sent to which device users, if and when any acknowledgements of those notifications were sent by client devices, and delete and/or amend the notifications and acknowledgments.

To receive notifications, client device(s) query the Admin System for new notifications at a fixed interval. However, it is contemplated herein that the notification may be communicated to client device(s) by being “pushed” to the client device. The device user receives the notification and either the client device itself sends an automatic acknowledgment, and/or the device user composes an acknowledgment, and that acknowledgment, which includes response data, is stored in the datastore. The response data is associated with the original notification, and the response data includes, for exemplary purposes only and without limitation, responses to the quiz or test that comprised the notification, a mere response that the notification has been read, such as “OK” or similar, and/or a text reply with substantive content.

It is contemplated herein that the described eportal system can be used in any similar situation, and the functionality can be applied in fields other than the educational field. For exemplary purposes only, and without limitation, the eportal system can also be used in the commercial field, wherein the users referred to as “students” may be employees of a company.

Accordingly, a feature of the ePortal system and method of use thereof is its ability to provide expanded functionality for users, such as, for exemplary purposes only, students.

Another feature of the ePortal system is its ability to prevent common users from negatively affecting performance of their devices.

Another feature of the ePortal system is its ability to easily allow communication to selected users.

Yet another feature of the ePortal system is its ability to monitor the results of these communications, and if they have been received and acknowledged.

Still another feature of the ePortal system is its ability to prevent users from acquiring unfiltered access to the World Wide Web.

Another feature of the ePortal system is its ability to allow for easy communications between superiors, such as teachers, and common users, such as students.

Another feature of the ePortal system is its ability to deliver content to the user, such as digital versions of text books eliminating the need to carry and/or transport such content.

Another feature of the ePortal system is its ability to enable communication between parent and teacher/administrator with regards to the device's assigned user, the student.

These and other features of the a system for registering and managing a distributed network of storage devices and method of use will become more apparent to one skilled in the art from the following Detailed Description of the Embodiments and Claims when read in light of the accompanying drawing Figures.

### BRIEF DESCRIPTION OF THE DRAWINGS

The present system for registering and managing a distributed network of storage devices and method of use will be better understood by reading the Detailed Description with reference to the accompanying drawings, which are not necessarily drawn to scale, and in which like reference numerals denote similar structure and refer to like elements throughout, and in which:

FIG. 1 is a schematic view of a system for using an ePortal system in an exemplary embodiment;

FIG. 2A is a flowchart showing exemplary initial steps to register a device;

FIG. 2B is a flowchart showing exemplary initial steps to register a device;

FIG. 3A is a flowchart showing exemplary steps of how notifications are propagated;

FIG. 3B is a flowchart showing exemplary steps of how notifications are propagated;

FIG. 4 is a flowchart showing exemplary steps of how an ePortal device is used;

FIG. 5 is a schematic view depicting the elements and relationships of notifications and network communications;

FIG. 6 is a schematic view of a system for using a storage device in a networked system in an exemplary embodiment; and

FIG. 7 is a flowchart showing exemplary steps of how a storage device is automatically added to a networked system.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

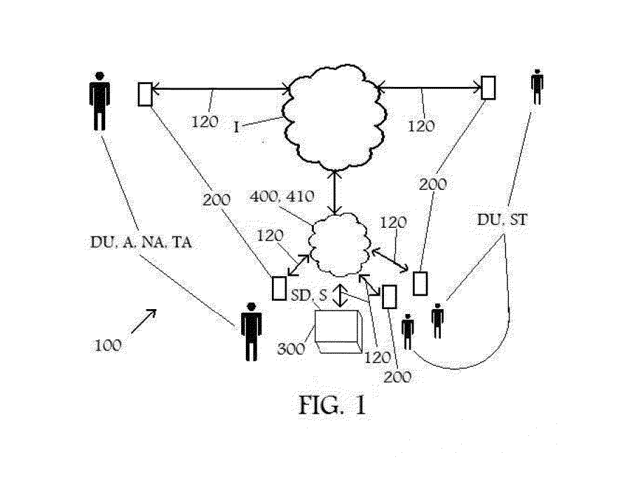

In describing the exemplary embodiments of the present disclosure, as illustrated in FIGS. 1-7, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-7 by way of example, and not limitation, therein is illustrated an eportal system 100, wherein eportal system 100 comprises device 200, server 300, network 400, and notifications 150, wherein network 400 comprises known wireless network 410 and new wireless network 420.

Device 200, a user device or computing device, comprises custom ROM 205, browser 210, applications 220, and unique portal number 240. Server 300 comprises Admin System 310, datastore 350, registration information 360, individual login 370, response data 381, notification content 382, and acknowledgement 383.

Eportal system 100, in an exemplary embodiment, can be used at schools S within school districts SD, wherein the device users DU comprise administrators A and students ST. Administrators A comprise network administrator NA and teacher administrators TA, wherein teacher administrators comprise class TC. Students ST comprise student ID SID and student grade level SG.

Turning more particularly, to FIG. 1, illustrated therein is a schematic view of a system for using an ePortal device in an exemplary embodiment. At school S, which is within school district SD, device users DU, such as administrators A and students ST use devices 200 that are connected to known wireless network 410. Administrators A and students ST that are not physically located at school, can connect devices 200 via internet I. It is contemplated herein that in some embodiments, networks 400 may be wired networks, such as the connection between server 300 and the network 400.

It is contemplated herein that device(s) 200 and network system 100 may be utilized in other than schools S within school districts SD and by other than device users DU comprise administrators A and students ST, such as for businesses and employees, and the like.

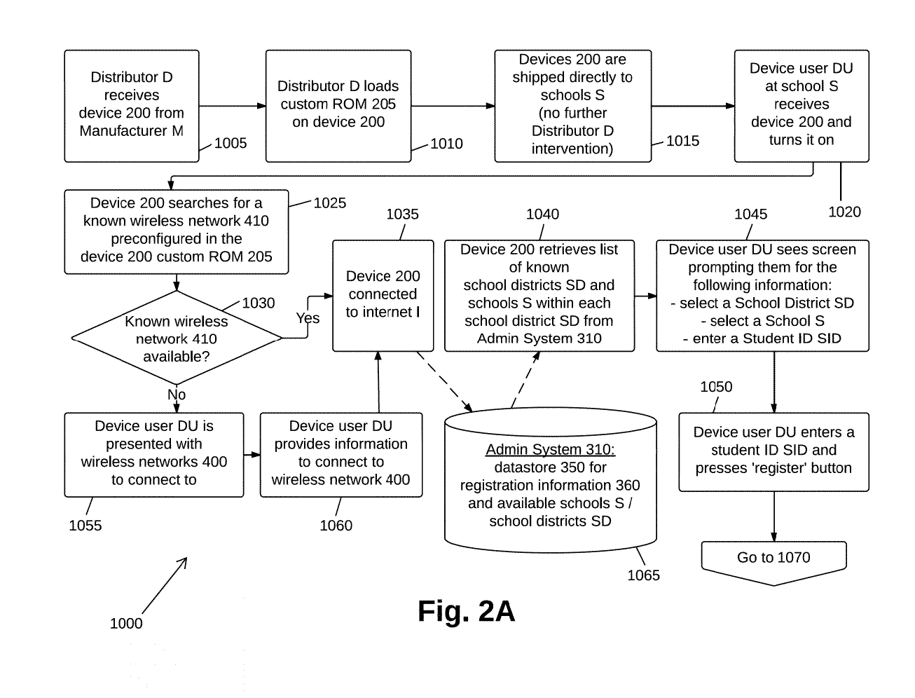

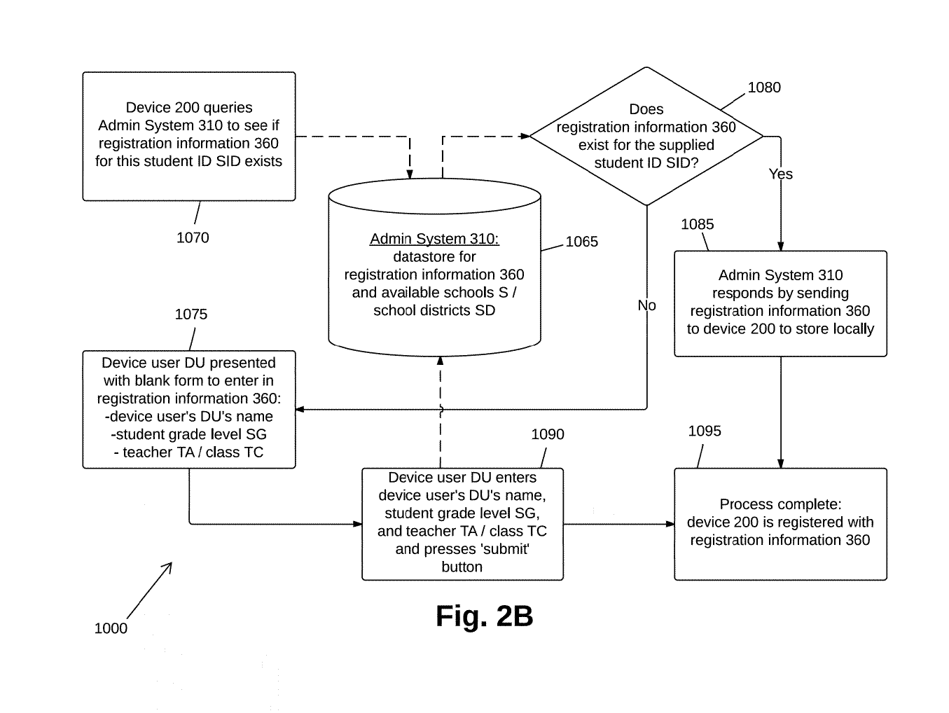

Turning now to FIGS. 2A and 2B, illustrated therein is a flowchart showing exemplary initial steps 1000 to register a device. Via step 1005 distributor D receives device 200 from manufacturer M. Next, via step 1010, distributor loads custom ROM 205 on device 200. In one embodiment, custom ROM 205 locks device 200 down to prevent anyone other than network administrator NA from configuring device 200, wherein the configuring includes, for exemplary purposes only, installing new software, installing new hardware, and using device's 200 ports for anything other than charging the battery. However, it will be recognized that custom ROM 205 may prevent anyone, including network administrator NA, from configuring device 200.

Via step 1015, devices 200 are shipped to schools S, and in this embodiment no further intervention by distributor D happens. Via step 1020, device user DU at school S receives device 200 and turns device 200 on, wherein device user DU at this step is administrator A. Device 200 searches for known wireless network 410 preconfigured in the device 200 custom ROM 205, via step 1025. At step 1030, device 200 determines if known wireless network 410 is available. If known wireless network 410 is available, device 200 connects to internet I via step 1035, wherein internet I at step 1035 is connected to known wireless network 410. If known wireless network 410 is not available, device user DU is presented network 400, which presumably includes new wireless networks 420, via step 1055. Via step 1060, device user DU provides information to connect to network 400, and proceeds to step 1035. Via step 1040, device 200 retrieves school district SD and school(s) S within school district SD from Admin System 310, wherein Admin System 310 is running on server 300, via 1065. Via step 1045, device user DU is prompted for school district SD, school S, and student ID SID, which are entered via step 1050.

Turning more particularly to FIG. 2B, via step 1070, device 200 queries Admin System 310 to see if registration information 360 exists for student ID SID. Via step 1080, if registration information 360 exists for supplied student ID SID, process proceeds to step 1085; otherwise, process proceeds to step 1075. Via step 1075, device user DU is asked for registration information 360, which comprises device user's DU's name, student grade level SG, and teacher TA and/or class TC, wherein the name entered is consistent with student ST associated with entered student ID SID. Via step 1090, registration information 360 requested via step 1075 is submitted, and subsequently device 200 is registered with registration information 360 via step 1095. Going back to step 1085, Admin System 310 sends registration information 360 to device 200.

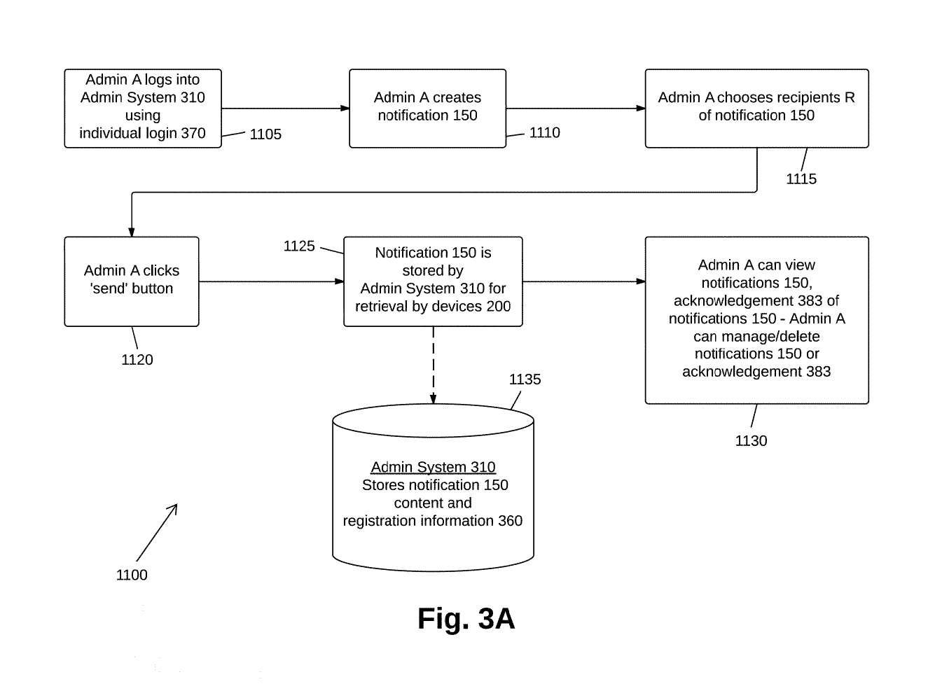

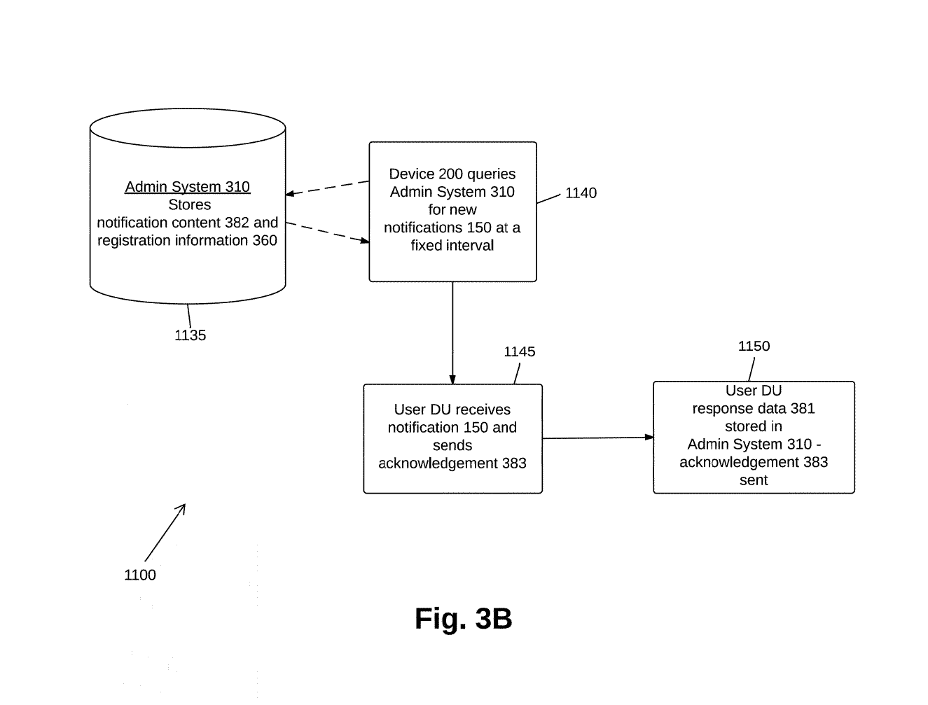

Turning now to FIGS. 3A and 3B, illustrated therein is a flowchart showing exemplary steps of how notifications are propagated 1100. It is contemplated and noted herein that those skilled in the art are familiar with the shorthand terminology “admin”, which can be used to refer to administrators A. Notification 150 comprises any type communication from server 300 to devices 200, or vice versa, including, for exemplary purposes only and without limitation, messages, questions for a quiz or test, and content, including multimedia content or links to any of above, wherein content may further include such things as emergency and/or administrative type communications to teachers. Further, notification 150 can be directed to recipients R, including, for exemplary purposes only and without limitation, all device users DU at school district SD, all users at school S, all students ST of a specific teacher administrator TA, all students ST of a certain class TC, wherein class TC describes either a subject or a expected graduating year, a single student ST, any device user DU, or any customized subgroup of above, supergroup of above, or combination thereof. For example, it is contemplated herein that notification 150 could be sent to all teachers TA during the school day that inclement weather is approaching and the students ST need to be moved to a safer location, or notification 150 could be sent to all teachers TA of certain student grade levels SG that a planned presentation has been canceled.

Via step 1105 administrator A logs into Admin System 310 using individual login 370, and wherein individual login 370 is associated with the specific administrator A. Via step 1110, administrator A creates notification 150. Administrator A chooses recipients R of notification 150, via step 1120. Via step 1125, notification 150 is stored by Admin System 310 for retrieval by devices 200, wherein notification 150 is stored in datastore 350 on server 300. Via step 1130, administrator A may view notifications 150, acknowledgement 383 of notifications 150, manage/delete notifications 150 or acknowledgments 383. More particularly, via step 1130, administrators A may view notifications 383 sent to which device users DU, if and when acknowledgements 383 of those notifications 150 was sent by devices 200, and delete and/or amend notifications 383 and acknowledgments 383.

Turning more particularly to FIG. 3B, via step 1140, device 200 queries Admin System 310 for new notifications 150 at a fixed interval. However, it is contemplated herein that notification 150 may be communicated to device 200 by being “pushed” to device 200, as such term is understood in the telecommunications arts. Via step 1145, device user DU receives notification 150 and sends acknowledgments 383, and subsequently, via step 1150, response data 381 from device user DU is stored in Admin System 310 in datastore 350.

After recipient R, who is user U of device 200, reads notification 150, acknowledgement 383 is sent to server 300, wherein acknowledgement 383 becomes response data 381, which is associated with original notification 150, and wherein response data 381 comprises, for exemplary purposes only and without limitation, responses to the quiz or test that comprised the notification 150, a mere response that notification 150 has been read, such as “OK” or similar, and/or a text reply with substantive content.

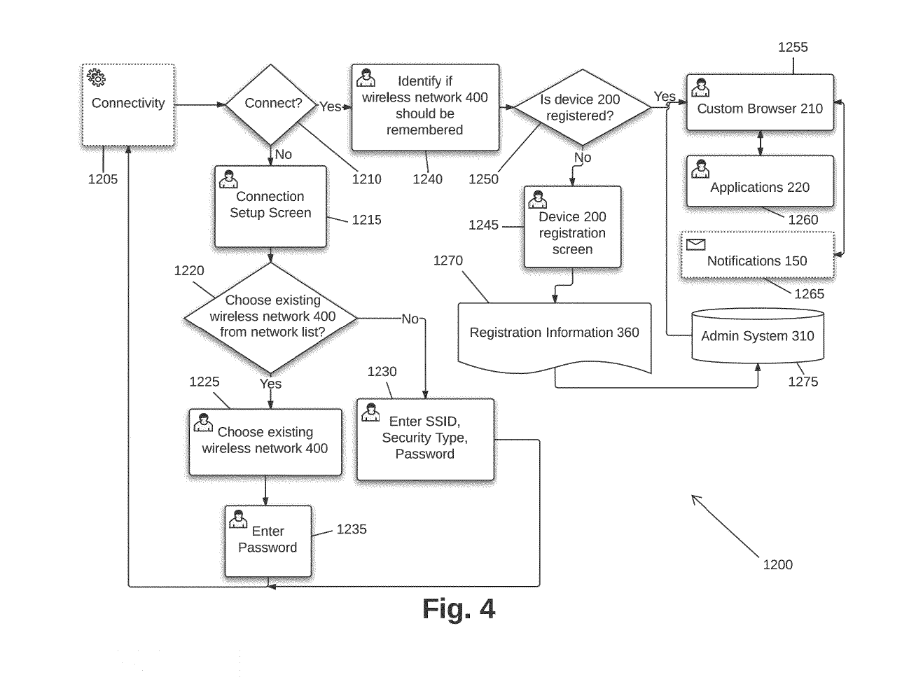

Turning now to FIG. 4, illustrated therein is a flowchart showing exemplary steps of how an ePortal device may be used 1200. Process 1200 starts via step 1205 and proceeds to step 1210, and wherein device 200 attempts to connect to Admin Server 310. If device 200 can connect, device user DU identifies if network 400 should be remembered via step 1240, and then process 1200 proceeds to step 1250. If not, a connection setup screen is shown via step 1215, and via step 1220 device user DU decides whether to choose from an existing network 400 broadcasting its presence. If not, via step 1230 the correct login information is entered, which is typically, although not necessarily, the SSID, security type, and password for network 400. If an existing network 400 is selected, such happens via step 1225, and via step 1230 the appropriate login information is entered for network 400.

Going back to step 1250, if device 200 is registered with Admin System 310, process 1200 proceeds to step 1255. If not, device 200 registration screen allows entering of registration information 360 via step 1270, which is then communicated to Admin System 310 via step 1275.

Subsequently, via step 1255, device 200 is used as designed. With the embodiment described in FIG. 4, such use comprises using custom browser 210 via step 1255, interacting with and seeing notifications 150 via step 1265, and using applications 220 via step 1260. It is contemplated herein that applications 220 comprise such computer software as, for exemplary purpose only and without limitation, calculators, an internet browser, and test or quiz taking software.

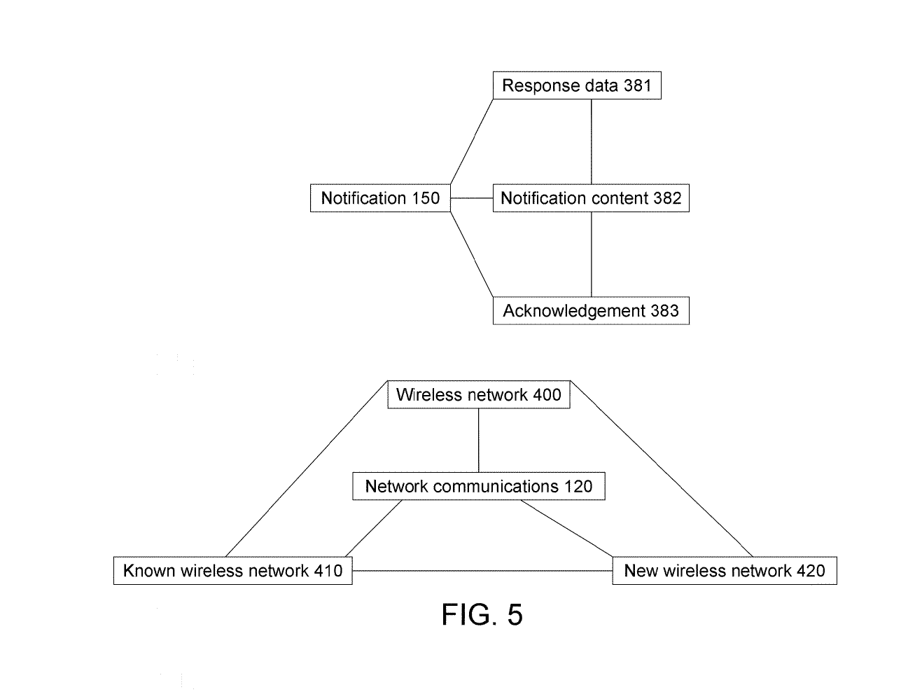

Turning now to FIG. 5, notification 150 relates to response data 381, notification content 382, and acknowledgement 383, which themselves are all related to each other.

It is contemplated herein that eportal system 100 can be used in any similar situation, and the functionality can be applied in fields other than the educational field. For exemplary purposes only, and without limitation, eportal system 100 can also be used in the commercial field, wherein students SD comprise employees.

It is further contemplated herein that network communications 120 from device 200 are routed through server 300, wherein server 300 thus manages what network communications 120 device 200 is allowed to conduct, and wherein the routing is accomplished through the device 200 treating server 300 as a proxy for network communications 120. In an alternate embodiment, device 200 creates a Virtual Private Network (VPN) with server 300, through which all network communications 120 from/to device 200 are channeled. In another embodiment, network communications 120 are forwarded to an electronic device on network 400 on or connected to server 300, wherein that electronic device functions as a firewall and/or filtering mechanism for network communications 120. It is contemplated herein that any and/or all of these combinations could be combined as would be recognized by those skilled in the art.

In one embodiment, device 200 comprises a tablet computer, but it is contemplated herein that device 200 may comprise any electronic device, mobile or otherwise.

It is contemplated herein that custom ROM 205 comprises a specifically designed operating system (OS) that controls the operation of device 200.

Referring again to FIG. 1 by way of example, and not limitation, therein is illustrated a system for registering and managing a distributed network of user and storage devices, network system 100, wherein network system 100 comprises device(s) 200, server 300, network 400, and communications 120, wherein network 400 comprises wireless and/or wired network 410 and/or wireless and/or wired network, such as the cloud or internet I. It is contemplated herein that network 400, wireless and/or wired network 410, and cloud or internet I preferably enable communication between device 200, server 300, network 400.

Device 200, a storage device, may comprise custom ROM 205, browser 210, applications or proprietary operating system 220, and unique portal number 240. Server 300 comprises Admin System 310, datastore 350, registration information 360, individual login 370, response data 381, notification content 382, and acknowledgement 383.

Turning more particularly, to FIG. 1, by way of example, and not limitation, there is illustrated an exemplary embodiment of a computing device, such as device 200 utilizing network system 100 to communicate therewith other device(s) 200 and server 300, connected to network 400 comprises wireless and/or wired network 410 and/or wireless and/or wired network, such as the cloud or internet I. At school S which is within school district SD, device users DU, such as administrators A and students ST, use computing device and storage device, such as devices 200 that are connected to network 400. Administrators A and students ST that are not physically located at school can connect to devices 200 via internet I. It is contemplated herein that in some embodiments, networks 400 may be wired networks, such as the connection between server 300 and the network 400.

Network system 100, in an exemplary embodiment, can be used at schools S within school districts SD, wherein the device users DU comprise administrators A and students ST. Administrators A comprise network administrator NA and teacher administrators TA, wherein teacher administrators comprise class TC. Students ST comprise student ID SID and student grade level SG.

It is contemplated herein that device(s) 200 and network system 100 may be utilized in other than schools S within school districts SD and by other than device users DU comprise administrators A and students ST, such as for businesses and employees and the like.

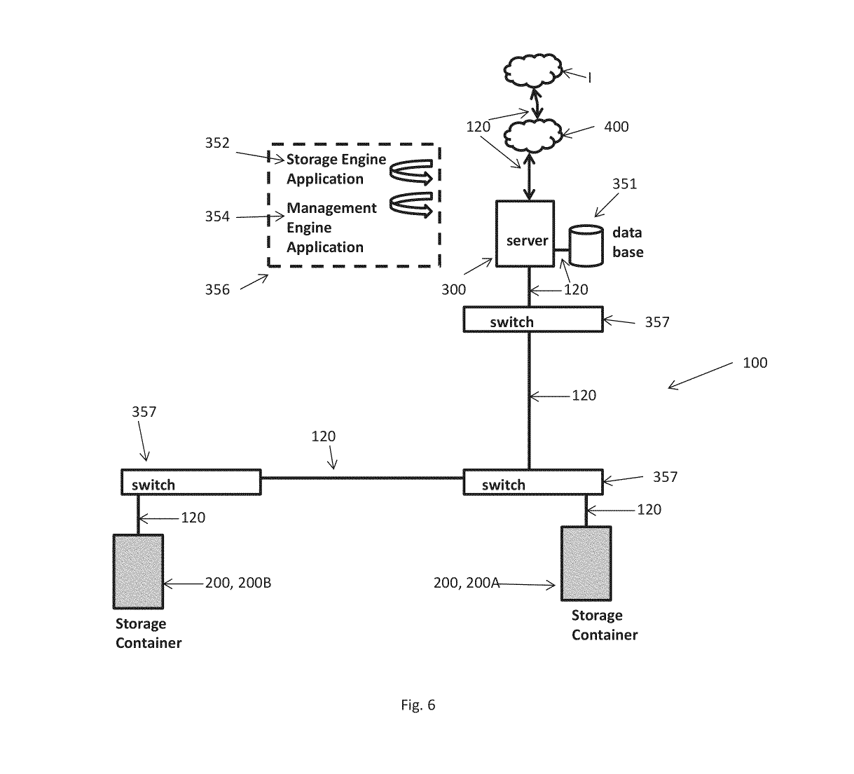

Turning more particularly, to FIG. 6, by way of example, and not limitation, there is illustrated an exemplary embodiment of a storage device, such as device 200 utilizing network system 100 to communicate therewith and perform storage services for device 200, other device(s) 200, and server 300, all connected to network 400 and/or internet I. At school S, which is within school district SD, device users DU, such as administrators A and students ST use storage device such as devices 200 that are connected to network 400. Administrators A and students ST that are not physically located at school can connect to storage device, such as devices 200 via internet I. It is contemplated herein that in some embodiments, networks 400 may be wired networks, such as the connection between server 300 and the network 400. Network system 100 further comprises existing storage devices, such as devices 200A and new or deployed storage devices, such as devices 200B, existing computing devices, such as devices 200A and new or deployed computing devices, such as devices 200B and networking switch 357. Preferably communications 120 designate communications between computing device, such as device 200A/B and other devices and applications on network system 100. Preferably networking switch 357 enables connection and communications 120 between storage device, such as device 200A/B, and other devices and/or applications on network system 100. Moreover, storage device, such as devices 200 may comprises custom ROM 205, applications or proprietary operating system 220, and unique portal number 240.

Preferably, networking switch 357 enables power over ethernet (POE) to power storage devices with 22-30 watts of power, such as storage devices 200, making device 200 pluggable into networking system 100 anywhere there is an Ethernet or other communication cable, such as communications 120 connected to networking switch 357.

Preferably, once powered, new or deployed storage devices, such as device 200 may utilize Link Layer Datagram Protocol (LLDP) an application that registers device 200 with system 100 via server 300 and networking switch(es) 357 as access points in system 100 to advertise information via communications 120 about such device(s) 200 to other nodes on system 100 such as computing device(s) 200, server 300, network 400 which comprises wireless and/or wired network 410 and/or wireless and/or wired network, such as the cloud or internet I (shown in FIG. 1).

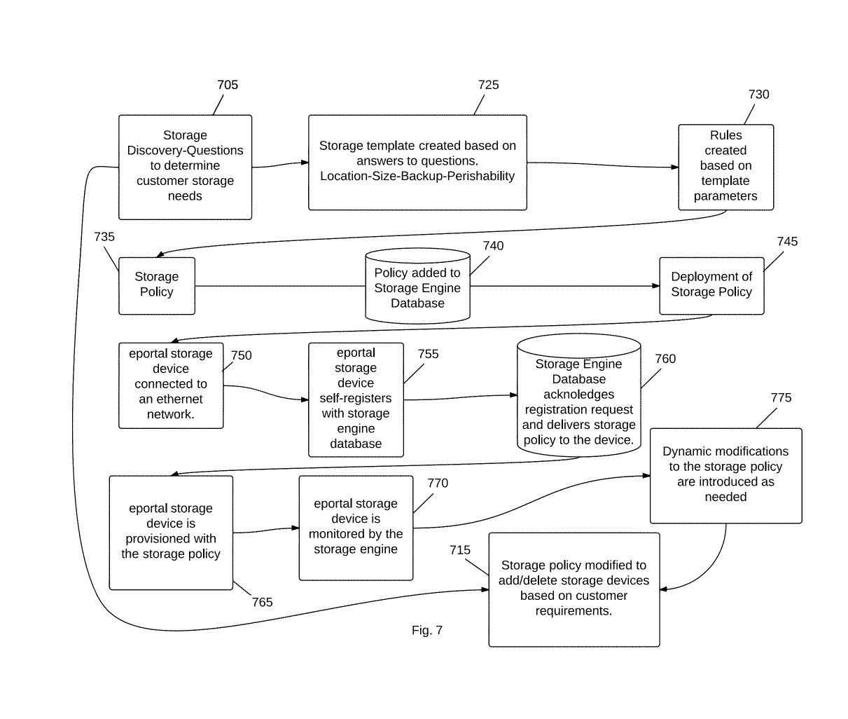

Moreover, system 100 preferably further includes database 351 connected to server 300. Preferably database 351 comprise computer software such as, for exemplary purpose only and without limitation, learning engine applications 356, includes storage engine 352 and management engine 354 (further disclosed in FIG. 7).

Turning now to FIG. 7, illustrated therein is a flowchart showing exemplary initial learning engine 356, such as storage engine 352 and management engine 354 to register storage devices 200 and gather and store information, such as status and storage needs of computing devices 200 and the status of storage devices 200, to specify operation tasks for storage devices 200, and to automatically move storage devices 200 to the correct virtual network 400 segments of system 100, as steps 700.

Via step 705 management engine 354 introduces or queries with discovery questions, for example, but not limited to storage device 200 to determine or collect storage location, size, whether for backup or perishability, type of storage and the like, to determine storage requirements of computing devices 200 (the system storage requirements) utilized by users DU, administrators A, students ST and administrators A comprise network administrator NA and teacher administrators TA of system 100 (the general rules of storage operation). Alternatively, management engine 354 general rules of storage operation may be modified or set by human managers, and such rules may include but are not limited to the general locations that storage should be added, the requirements for primary and back up storage, or storage specified by application or service, and the general locations of storage devices 200 in relation to each other (the general rules of storage operation). These general rules of storage operation will then be used by management engine 354 to allocate storage roles or rules, such as storage policy 735 to the installed storage devices 200.

Management engine 354 stores the status information on all storage devices 200 of networking system 100 and compares such information with the storage roles or rules, such as storage policy 735 or that provided by (human) managers, and then send computing devices 200 and those managers timely and current information on the status of all storage devices 200 in relation to the storage roles or rules, such as storage policy 735, informing of storage devices 200 need to be installed in networking system 100 to meet the storage roles or rules, such as storage policy 735 of networking system 100. Management engine 354 preferably monitors each installed storage devices 200 for the status of its storage (functional, available, or defective storage, available storage as in online or offline, the function of the storage, and the like) and the status of its power supply, the heat of the enclosure, the status of its network connections, the status of its own operating system (software version, defective operating system memory, operation of the component parts of its own operating system, and the like) (the system storage requirements), and the status of network traffic. The status of storage or network traffic on networking system 100 may be relayed or communicated to computing device 200 or the (human) managers for corrective action.

For example, management engine 354 may identify that storage device 200 own storage capacity is being utilized at a specified rate and that currently storage device 200A has ten percent (10%) remaining capacity, and thus management engine 354 triggers the addition of storage device 200B by informing or communicating to (human) managers for corrective action, such as order an plug in a new storage device 200.

It is further contemplated herein that management engine 354 may be a made redundant, to protect from outages of management engine 354.

It is still further contemplated herein that management engine 354 operates with a higher utilization of storage device(s) 200 in networking system 100.

Via step 715 management engine 354 enables dynamic modifications to storage policy of networking system 100 to enable management as a whole of the storage requirements of system 100 where management engine 354 is preferably modifying the storage policy, steps 700, of system 100 based on the status and tasks of storage devices 200 that provide storage services to computing devices 200 on system 100.

Via step 715 management engine 354 enables storage policy, steps 700, modifications, such as to add or delete storage devices 200 to system 100 based on management engine 354, such as calculated requirements or forecasted requirements of computing devices 200 of users DU, administrators A, students ST and administrators A comprise network administrator NA and teacher administrators TA of system 100 or other system storage requirements.

Via step 725 management engine 354 creates storage templates based on answers or feedback from discovery questions, for example, but not limited to storage device 200 requirements of location, size, whether for backup or perishability type of storage and the like (the system storage requirements), to determine storage requirements of computing devices 200 utilized by users DU, administrators A, students ST and administrators A comprise network administrator NA and teacher administrators TA of system 100 or other system storage requirements.

Via step 730 management engine 354 creates rules for storage policy 735 based on storage template parameters, which may be based on answers or feedback from discovery questions, for example, but not limited to storage device 200 requirements of location, size, whether for backup or perishability type of storage and the like, to determine storage requirements of computing devices 200 utilized by users DU, administrators A, students ST and administrators A comprise network administrator NA and teacher administrators TA of system 100 or other system storage requirements.

It is contemplated herein that storage policy 735 governs the operation of storage device(s) 200.

It is further contemplated herein that system 100 may network a variety of storage devices 200 and storage purposes since each storage device 200 is given its operating guidance from management engine 354. For example, management engine 354 rules may assign storage devices 200 with the task of providing primary or back-up storage, or some other storage task or other system storage requirements, which provide many different storage functions and capabilities from the same storage device 200.

Via step 740 management engine 354 adds storage policy 735 to storage engine 352 and stores or updates storage policy 735 (the system storage requirements) in database 351.

Via step 745 storage engine 352 deploys storage policy 735 within system 100.

Turning now to FIGS. 2A and 2B, illustrated therein is a flowchart showing exemplary initial steps 1000 to register storage device 200. Via step 1005 distributor D receives device 200 from manufacturer M. Via step 1010, manufacturer M has previously loaded custom or specifically designed operating system (OS), such as proprietary operating system 220 that controls the operation of device 200, storage engine 352 automatically discover storage engine 352 and register storage device 200 with storage engine 352 and/or management engine 354, which controls, assigns roles, updates, and maintains functional operation of storage device 200 toward a common storage system purpose set forth in storage policy 735.

It is contemplated herein that system 100 enables automatic plug and use of storage device 200 without the assistance of qualified IT personnel. For example, an installer merely has to unbox storage device 200B and connect it to networking switch 357 and storage engine 352 automatically includes storage device 200B in the storage system and assigns storage device 200B a new role in system 100 based on storage policy 735.

Via step 750, new or deployed devices 200, such as devices 200B or storage device 200B is preferably pluggable into networking system 100 anywhere there is an Ethernet or other communication cable, such as communications 120 connected to networking switch 357. Preferably networking switch 357 provides power to new or deployed devices 200, such as devices 200B or storage device 200B via power over ethernet (POE) to power storage device 200B making them pluggable into the network anywhere there is an Ethernet cable connected to networking switch 357. Moreover, once powered, storage device's 200B previously loaded custom or specifically designed operating system (OS), such as proprietary operating system 220 that controls the operation of device 200 loads into the CPU and computer memory of the storage device.

Via step 755, storage engine 352 preferably automatically discovers or receives a registration request from storage device 200B, communicates information via communications 120, and registers new or deployed devices 200, such as devices 200B or storage device 200B with storage engine 352 and stores such information in database 351. Moreover, storage engine 352 via server 300 and networking switch 357 utilize Link Layer Datagram Protocol (LLDP) an application that registers new or deployed devices 200, such as devices 200B or storage device 200B with networking switch 357 and networking system 100 as access points in a network to advertise or communicate information about such devices 200 to other nodes on networking system 100 and to enable storage engine 352 to gather and store information, such as status and storage needs of the networked computer devices, such as computing devices 200 and the status of the networked storage devices 200, and to enable storage engine 352 to move storage device 200B to the correct virtual segment of networking system 100. Preferably automatic registration happens between storage engine 352 and new or deployed devices 200, such as devices 200B or storage device 200B, as soon as devices 200B is attached to networking switch 357 or any network connection, and includes the provision or communication of at least the following information to storage engine 352: the network location that storage device 200B is installed, unique portal number 240, such as MAC or machine address (MAC and machine addresses are unique numbers generated by the manufacturer and built into the hardware components of storage device 200B), the types and speeds of the network connections that bind storage device 200B to the local network, such as network 400, and the type and size of storage specifications of storage device 200B.

Via step 760, storage engine 352 preferably acknowledges registration request from new or deployed device(s) 200, such as device(s) 200B or storage device 200B and delivers or communicates storage policy 735 to new or deployed device(s) 200, such as storage device 200B. Preferably storage policy 735 may include predetermined rules for the deployment and use of new or deployed device(s) 200, such as storage device 200B based on the types and speeds of the network connections of networking system 100 that bind this new or deployed device(s) 200, such as storage device 200B to the local network, the type and size of storage required by computing devices 200, and the type and size of storage capabilities of the new or deployed device(s) 200, such as storage device 200B (the system storage requirements).

Via step 765, new or deployed device(s) 200, such as device(s) 200B or storage device 200B is preferably provisioned (communicates) by storage engine 352 with storage policy 735. Preferably storage engine 352 provides information back to storage device 200B, such as to assigns storage device 200B to a specific task providing primary storage to a virtual segment of networking system 100 or to one or more ePortal networked computer devices, such as existing, new, or deployed computing device(s) 200B, or providing backup storage to one or more ePortal networked computer devices, such as existing, new, or deployed computing device(s) 200B (the storage task). Any storage device 200B may have more than one storage task assigned it via storage policy 735. Moreover, the storage system of networking system 100 is much easier to custom provision, install, modify, increase, or decrease storage device(s) 200B than conventional storage systems, because storage device 200B automatically register themselves with storage engine 352 without the need of resident IT personnel and without the need for individual configuration of storage device(s) 200B.

Via step 770, storage engine 352 preferably monitors existing storage devices, such as devices 200A and new or deployed storage devices, such as devices 200B, existing computing devices, such as devices 200A and new or deployed computing devices, such as devices 200B. Moreover, storage engine 352 preferably communicates with existing storage devices, such as devices 200A and new or deployed storage devices, such as devices 200B, existing computing devices, such as devices 200A and new or deployed computing devices, such as devices 200B and other networked computer devices to determine the status and storage needs of networking system 100 (the status requirements), and thus, enable the system for registering and managing a distributed network of storage devices and method of use to adapt to the storage requirements of the devices 200 of networking system 100.

Via step 775 storage engine 352 preferably makes dynamic modifications to storage policy 735 whether automatically based on the status and storage needs of networking system 100, the status and storage needs of a segment of networking system 100, the status and storage needs of existing computing devices, such as devices 200A and new or deployed computing devices, such as devices 200B and other networked computer devices. Moreover, storage engine 352 has information on the number and location of existing storage devices, such as devices 200A and new or deployed storage devices, such as devices 200B, the rules for deployment and use of such storage devices, such as storage policy 735, and the storage needs of ePortal networked computer devices, such as existing computing devices, such as devices 200A and new or deployed computing devices, such as devices 200B and of other, associated networked computing devices (the storage requirements). Preferably storage engine 352 utilizes these rules (the storage requirements), such as storage policy 735, to manage the association of each existing storage devices, such as devices 200A and new or deployed storage devices, such as devices 200B within networking system 100, and the management of the use rules, such as storage policy 735 for each new or deployed computing devices, such as devices 200B.

It is contemplated herein that storage engine 352 provides information back to ePortal networked computer device, such as devices 200, information such as the storage availability or status in any location or segment of networking system 100. Storage engine 352 may alternatively advertise the storage status directly to the ePortal networked computer devices, such as devices 200 or to other networked computers when necessary, and provide them rules, such as storage policy 735, for storing information on storage devices 200.

It is further contemplated herein that storage engine 352 can insure or make available stored data or storage services with sufficient redundancy, set in its storage policy 735, in networking system 100, based on stored data's classification and priority. Some data in networking system 100 may not have redundant storage; some data in networking system 100 may have redundant storage. Some more critical data may also have an even higher level of redundant storage. Data may be made redundant in the same storage devices 200; it may be made redundant in several storage devices 200, and based on the need for disaster recovery, it may be made redundant on different storage devices 200 in different locations of networking system 100.

It is still further contemplated herein that storage engine 352 is also aware of the status of storage devices 200, such as whether storage device(s) 200 are online or offline, and based on such information storage engine 352 can redirect storage to other backup storage device(s) 200 by modifying the storage policy 735 of one or more storage device(s) 200.

It is still further contemplated herein that storage engine 352 automatically registers storage device(s) 200 with a central manager, management engine 354, which then controls, assigns roles, updates, and maintains functional operation toward a common storage system purpose.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A distributed network storage system, said storage system comprising:
a server;
network communications; and
a storage device, wherein said storage device and said server communicate via network communications, and wherein said storage device comprises a custom operating system, and wherein said storage device comprises a custom storage policy provided by a storage engine on said server, and wherein said storage device provides plug and play storage services via said network communications.

2. The storage system of claim 1, wherein said storage device registers with said storage engine, and wherein said storage device is configured to implement said storage policy.

3. The storage system of claim 2, wherein said storage system further comprises a networking switch, wherein said networking switch utilizes link layer datagram protocol (LLDP) to register said storage device.

4. The storage system of claim 1, wherein said storage system further comprises a networking switch, wherein said networking switch enables power over ethernet (POE) to power said storage device.

5. The storage system of claim 3, wherein said storage engine communicates a query via said network communications to said storage device, and wherein said query is utilized to configure said custom storage policy of said storage engine.

6. The storage system of claim 5, wherein said storage device provides a response to said query via said network communications, and wherein said response is utilized to configure said custom storage policy of said storage engine.

7. The storage system of claim 6, wherein said storage engine requests the addition of a new storage device based on said storage policy, and wherein said new storage device comprises a revised storage policy provided by said storage engine, and wherein said storage device provides plug and play storage services via said network communications.

8. A method for adding storage to a network storage system, wherein said method comprises the steps of:
plugging a storage device into a communication cable in communication with a networking switch in network communication with a server, wherein said storage device is configured with a proprietary operating system, wherein said storage device is powered via a power over Ethernet via said networking switch;
registering said storage device with said server via a storage engine; wherein said storage engine utilizes link layer datagram protocol (LLDP) communication between said storage device and said networking switch; and
wherein said storage engine communicates a storage policy to said storage device, and wherein said storage policy governs an operation of said storage device.

9. The method of claim 8, wherein said storage policy includes a storage task.

10. The method of claim 8, said method further comprising the step of:
monitoring said storage device and a computing device in network communication via said server, wherein said storage engine collects status requirements from said storage device and said computing device via a server in network communication therewith.

11. The method of claim 10, said method further comprising the steps of:
modifying said storage policy of said storage device based on said storage requirements of said storage device and said computing device.

12. The method of claim 11, wherein said storage device further comprising the steps of:
executing said storage policy.

13. The method of claim 10, wherein said storage device further comprising the steps of:
providing storage services for said computing device.

14. The method of claim 10, wherein said storage device further comprising the steps of:
providing backup storage services for said computing device.

15. The method of claim 10, further comprising the steps of:
communicating a storage status to said computing device.

16. A method for managing a network storage system, wherein said method comprises the steps of:
providing a storage device in communication with a networking switch in network communication with a server and a computing device in network communication with said server;
querying said computing device to determine a system storage requirement;
querying said storage device to determine a system storage requirement;
generating a general rule of operation via a management engine on said server, wherein said management engine establishes a storage policy to govern an operation of said storage device.

17. The method of claim 16, wherein said storage policy includes a storage task.

18. The method of claim 16, said method further comprising the step of:
monitoring said storage device and a computing device in network communication with said server, wherein said management engine collects system status requirements from said storage device and said computing device via a server in network communication therewith.

19. The method of claim 18, said method further comprising the steps of:
modifying said storage policy of said storage device based on said system storage requirements of said storage device and said computing device.

20. The method of claim 19, further comprising the steps of:
communicating a storage status to said computing device.
